(19) United States
(12) Patent Application Publication
(10) Pub. No.: US 2005/0070413 A1
(43) Pub. Date: Mar. 31, 2005

(54) Bag topper device

(76) Inventor: James W. Morgan, Walton, KY (US)

Correspondence Address: DANIEL B. RUNK, 1400 PROVIDENT TOWER, ONE EAST FOURTH STREET, CINCINNATI, OH, 45202, US

(21) Appl. No.: 10/660,316

(22) Filed: Sep. 11, 2003

(51) Int. Cl. B31B 1/86

(52) U.S. Cl. 493/226

(57) ABSTRACT

A product carrying and storage device that comprises a bag with handles and a bag topper device with handle openings in which contents are placed into the bag and the topper device is then guided onto the handles of the bag to protect and insulate the interior contents.

### FIELD OF INVENTION

This invention relates generally to the field of product packaging materials, more specifically, to a bag utilizing a bag top apparatus.

### BACKGROUND OF THE INVENTION

Packaging materials are obviously used in a number of industries to deliver products to end consumers. In many of these industries, bags are used to enclose the product and permit easy transport by the consumer. Bags are a popular choice since they can be made from a variety of materials (e.g. paper, plastic, vinyl, etc.) and are relatively inexpensive. Bags can also be easily designed to accommodate a particular purpose, such as a shopping bag, lunch bag, heavy duty tote bag, etc. Boxes are popular for their structural rigidity and scalability, however, they are frequently bulky and more expensive than other materials.

Bags are often used to transport food products and/or items that are delicate. For food items, the top of the bag is typically rolled down to keep the food inside somewhat insulated from the external atmosphere. This results in reduced available volume for the food products and can also result in compression of the food items. For delicate items, bags are typically made with greater thicknesses and reinforced panels to increase the structural integrity of the bag; however, the bag still typically has a relatively weak upper portion.

Within the food product field, bags have been fabricated to increase the structural rigidity and provide atmospheric protection with using the foregoing methods. In U.S. Pat. No. 4,877,337 by Wood, an approach is disclosed in which a plastic top cover is thermosealed to fairly standard plastic bag thereby sealing the contents and providing structural reinforcement around the top portion of the bag. However, this approach requires special assembly equipment, creates a permanent seal and provides only limited structural support. Another approach for providing an enclosed top with structural reinforcement is shown in U.S. Pat. No. 4,018,142 by Canno. In the '142 patent, the bag top is folded similar to a box and a handle is drawn through a slot opening in the top. While this approach provides certain advantages, it provides the user with only a single handle, creates a taller bag into which the items must be raised farther prior to placement in the bag, requires scoring of the bag top to enable easy assembly, requires multiple folding steps in its assembly and creates a top that cannot easily be unfolded or lifted to permit quick access to the bag interior.

Boxes have been used as the material of choice for certain relatively delicate food items, such as doughnuts. The boxes are shipped flat to their end destinations and are usually assembled individually prior to placing product inside of the box. This process is inefficient as it requires assembly of the box prior to taking a customer's order and it uses a more expensive box instead of a less expensive bag. Also, the box is not equipped with handles for convenient transport.

Accordingly, as mentioned, the existing bags and boxes intended for holding products include significant limitations. As a result, significant improvement can still be made relative to creating a less expensive and more convenient product holder.

### SUMMARY OF THE INVENTION

The present invention is intended to provide an improved product holder that is less expensive, easier to assemble and use, and has increased structural integrity to protect its contents as compared with existing holders.

The product holder is generally comprised of a bag with opposing handles adjacent to the bag opening and a bag topper that fits over the bag opening. The bag topper is formed with a substantially flat top and sides that extend downward to fit over the sides of the bag. The topper has slits in at least two sides that fit over the handles and hold the topper in place. In a preferred embodiment, the bag is a foldable rectangular paper bag and the topper is a foldable cardboard topper. This permits shipping the toppers as flat pieces while enabling easy assembly. In the preferred embodiment the bag is made from 57# Kraft paper with Kraft paper twisted handles and the topper is eighteen point bending chip board. If desired, graphics can be printed on the bag and/or topper.

One advantage of the present invention is that the bag topper provides increased structural rigidity for the bag. Another advantage is that the bag and topper is less expensive to manufacture. Another advantage of the invention is that the topper helps protects the contents against the exterior environment, including insulating hot or cold products. Another advantage is that products can be easily inserted into the bag container prior to placing the topper on the bag, and the top can easily be removed to insert or remove products in the bag. Another advantage of the invention is that the topper can be removed and used as a tray for the contents. Another advantage is that the product provides better graphic surfaces for advertising than other alternatives such as boxes. Another advantage is that the bag and topper can be manufactured from recycled materials certified for food contact. Another advantage is that the bag and topper generates waste that is more easily degradable than alternative materials such as plastic or wax coated papers.

### BRIEF DESCRIPTION OF THE DRAWINGS

FIGS. 1A and 1B are folded and expanded perspective views of the bag portion of one embodiment of the present invention.

FIGS. 2A and 2B are folded and expanded perspective view of the bag topper portion of one embodiment of the present invention.

FIG. 3 is a bottom template view of the bag topper portion of the present invention shown in FIGS. 2A and 2B.

FIGS. 4A, 4B and 4C are perspective views of the bag and topper portions of the present invention separated, combined and being used.

### DETAILED DESCRIPTION

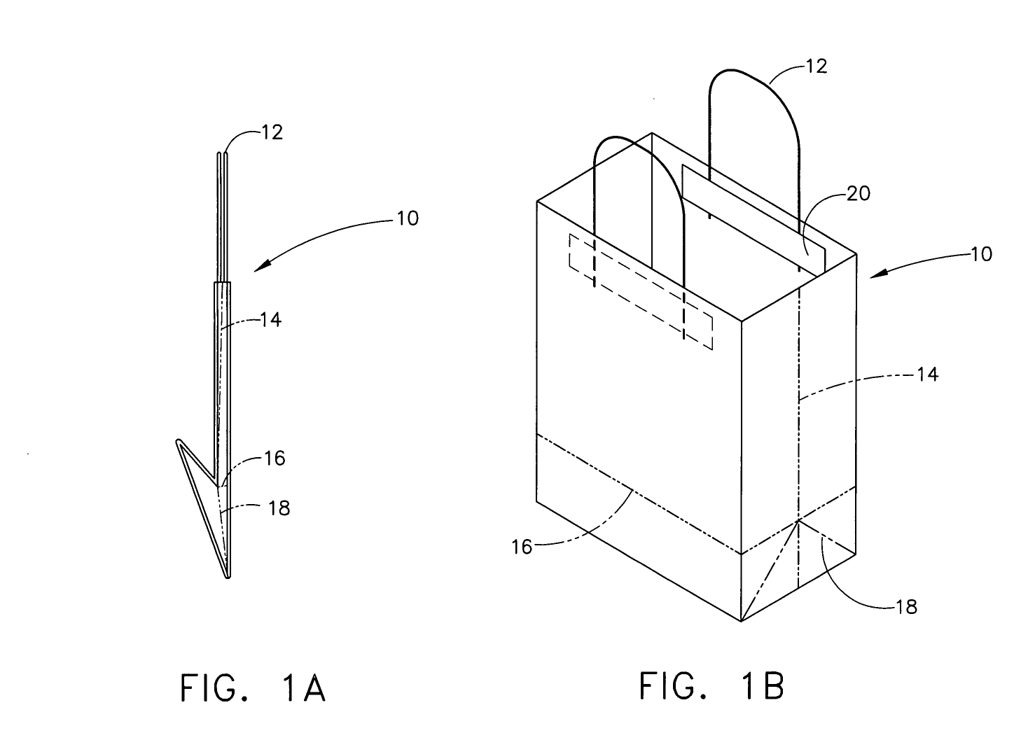

FIGS. 1A and 1B illustrate one embodiment of the bag 10 portion of the bag holder. The bag 10 is folded along a side fold 14, a base fold 16 and bottom folds 18 to permit the bag 10 to be folded flat as shown in FIG. 1A. The bag 10 also has handles 12 which are attached to the inside of opposing sides of the bag by sandwiching the handles 12 between a paper strip 20 and the inside of bag 10.

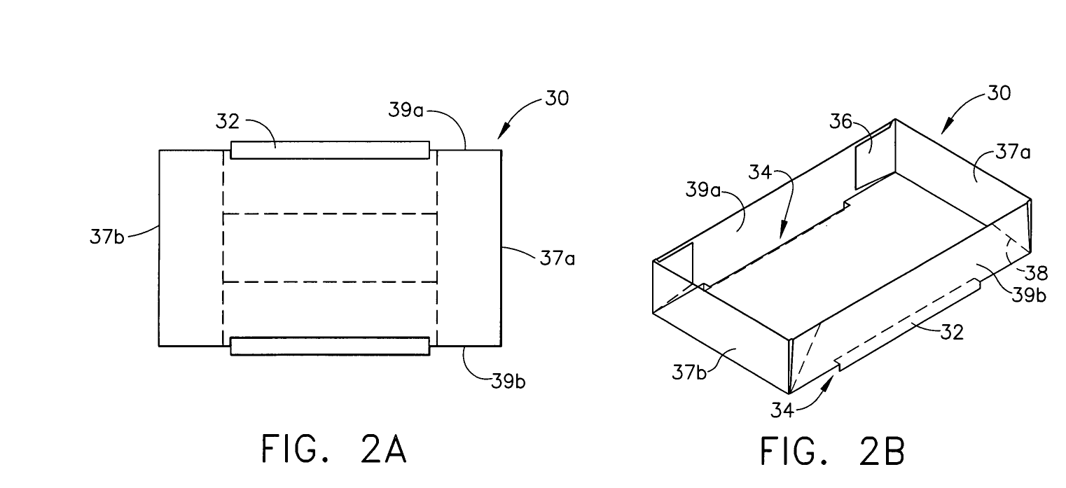

The bag 10 topping device is illustrated in FIGS. 2A and 2B. In FIG. 2A the topper 30 is folded into a generally rectangular shape with minor guide flaps 32 projecting from the opposing handle sides 39a and 39b. In FIG. 2B the topper 30 is unfolded further revealing the handle openings 34 in the opposing handle sides 39a and 39b and the end flaps 36 that connect the opposing sides 37a and 37b to the opposing handle sides 39a and 39b. Unfolding also reveals the collapsing folds 38 that permit the topper 30 to be folded flat as shown in FIG. 2A.

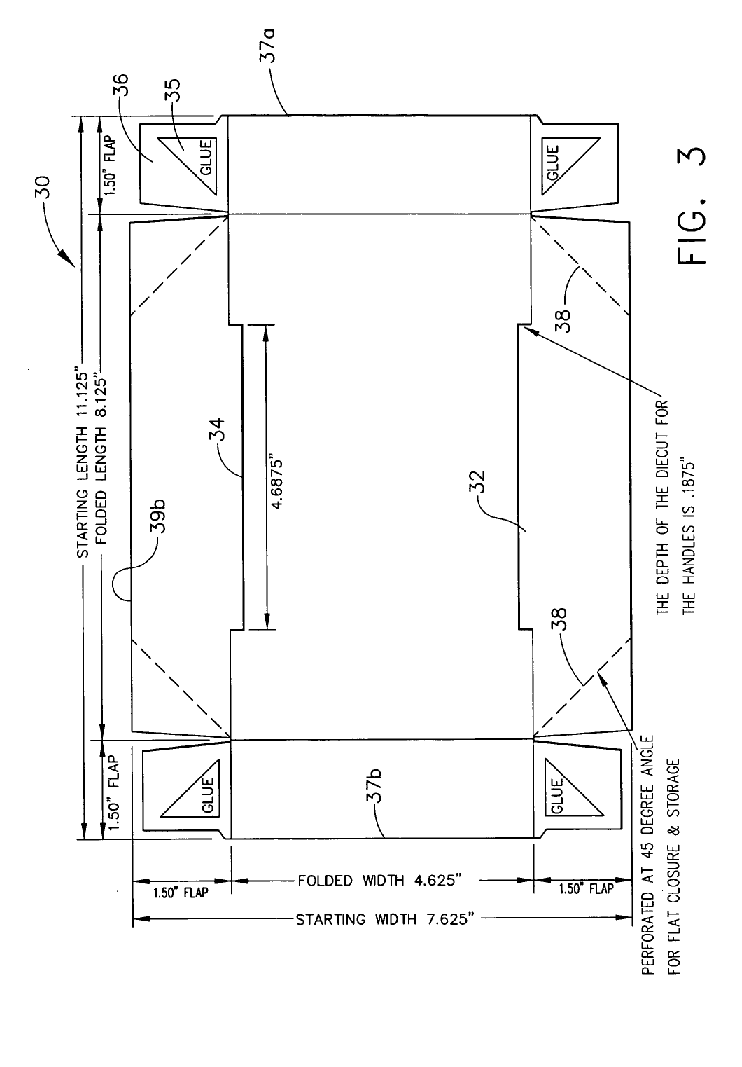

FIG. 3 further illustrates the topper 30 in template form. The template shows the attachment points 35 which are attached to the inside portion of the opposing handle sides 39a and 39b to connect them to the opposing sides 37a and 37b. Such attachment points 35 can be attached by a variety of means, including glue, staples, rivets, etc. The template in FIG. 3 also illustrates the area to be die cut along the common area designating the guide flap 32 and handle opening 34.

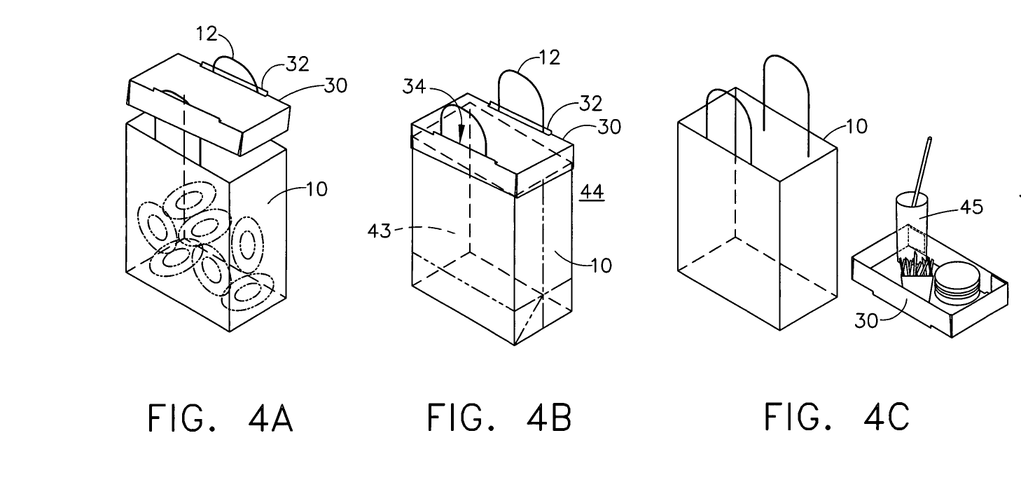

FIGS. 4A, 4B and 4C illustrate the bag 10 and topper 30 in use. The handles 12 of the bag 10 are pulled through the handle openings 34 of the topper 30 and onto the top of the bag 10 as shown in FIGS. 4A and 4B. The guide flaps 32 assist in guiding and holding the handles 12 in place. Upon placement of the topper 30 onto the bag 10 the interior environment 43 of the bag 10 is protected from the exterior atmosphere 44. The topper 30 can then be removed from the bag 10 and used as a tray for food 45 as shown in FIG. 4C.

The preceding description of the invention has shown and described certain embodiments thereof; however, it is intended by way of illustration and example only and not by way of limitation. Those skilled in the art should understand that various changes, omissions and additions may be made to the invention without departing from the spirit and scope of the invention.

1. A product carrying and storage device comprising:
a bag having an opening and having one or more handles adjacent to said opening; and
a bag topper having one or more handle openings wherein said one or more handles of said bag can each be passed through said one or more handle openings to attach said topper to said bag and said topper substantially covers the entirety of said opening.

2. The device described in claim 1 wherein said bag has front and rear panels and a pair of gusseted side panels connecting said front and rear panels and a flat-style folded and glued bottom panel connected to said front and rear panels and said side panels are constructed to move between a folded storage position adjacent said front or said rear panel and said bottom panel is substantially parallel and adjacent to said front and rear panels and said side panels.

3. The device described in claim 2 wherein said topper has a top panel, front and rear panels and a pair of side panels and said top panel substantially covers the entirety of said opening of said bag upon placing said handle through said handle openings and wherein said front and rear panels and said side panels of said topper device overlap the corresponding said front and side panels and said pair of side panels of said bag upon placement of said topper device on said bag.

4. The device described in claim 3 wherein said bag is made from paper and said topper device is made from cardboard.

5. The device described in claim 3 wherein said bag has two handles and said topper device has two handle openings.

6. The device described in claim 3 wherein said topper device is constructed to move between a folded storage position wherein an overlapping triangular portion of said front panel and said side panel of said topper device are folded resulting in said front panel and said side panel laying substantially flat adjacent to said top panel.

7. The device described in claim 3 wherein said topper device is formed from a single sheet of material having portions around the perimeter of said top layer that are folded to form said front and rear panels and said side panels and wherein each of said side panels also includes two flaps that fold and are attached to said front and rear panels respectively.

8. The device described in claim 7 wherein said handle openings are formed in said single sheet of material by creating a partial cut that results in handle guide material from said top panel being pivoted in continuity with said front and rear panels as the perimeter portions of said single sheet of material are folded thereby creating said handle opening in the evacuated area of said handle guide material.

9. A method of forming and using a product carrying and storage device comprising the steps of:
unfolding a bag having front and rear panels and a pair of side panels attached to a bottom panel with two handles, one handle each being respectively attached to said front and rear panels of said bag;
unfolding a topper device having front and rear panels and a pair of side panels attached to a top panel with two handle openings on the sides of said top panel located adjacent to said front and rear panels; and
inserting said handles through said handle openings to place said topper device on said bag.

10. The method described in claim 9 wherein prior to said inserting step the method further comprises the step of placing a product into said bag.

11. The method described in claim 10 wherein said method further comprises the steps of:
removing said topper device by pulling said handle openings off of said handles; and
turning said topper device upside down so that said top panel is located beneath said front and rear panels and said side panels of said topper device; and
using said topper device as a tray for said products in said bag.
